(19) United States
(12) Patent Application Publication
(10) Pub. No.: US 2020/0099999 A1
(43) Pub. Date: Mar. 26, 2020

(54) BELT HAVING A DATA-TRANSFERRING DEVICE

(71) Applicant: ContiTech Antriebssysteme GmbH, Hannover (DE)

(72) Inventors: Tim Fiss, Hannover (DE); Reck Siegfried, Nienburg (DE); Svenja Lueker, Hannover (DE)

(73) Assignee: ContiTech Antriebssysteme GmbH, Hannover (DE)

(21) Appl. No.: 16/469,713

(22) PCT Filed: Nov. 2, 2017
(86) PCT No.: PCT/EP2017/077991

§ 371 Date: Jun. 14, 2019

(30) Foreign Application Priority Data
Dec. 15, 2016 (DE) 10 2016 225 185.6

(51) Int. Cl. H04Q 9/00; G01M 13/023; B65G 15/30; F16G 1/22

(52) U.S. Cl. CPC H04Q 9/00; G01M 13/023; B65G 15/30; H04Q 2209/886; H04Q 2209/82; H04Q 2209/883; F16G 1/22

(57) ABSTRACT

The invention relates to a belt (1) having a rear surface (2), having a data transmission device (3, 6, 7, 8, 9, 10), wherein the data transmission device (3, 6, 7, 8, 9, 10) has at least one sensor (6) having an energy supply and at least one external reader (9). The invention is based on the object of designing the data transmission device mentioned at the outset such that data from a moving belt (1) are able to be reliably transmitted to a stationary receiver (9). This object is achieved in that spaced signal surfaces (3) are arranged on the rear surface (2) of the belt (1) in the running direction of the belt (1), and each signal surface (3) is able to be switched either into a first active state or into a second inactive state by the sensor (6), wherein a positive signal is able to be transmitted in the first active state and either a negative signal or no signal is able to be transmitted in the second inactive state, and the respective state of the signal surfaces (3) is able to be acquired by the external reader (9) when the moving belt (1) runs past. Since only one item of binary information is able to be transmitted per signal surface (3), the information density, even when the signal surfaces (3) run past the reader (9) at high speed, is low enough that it is possible to reliably acquire the states of the signal surfaces (3). Reliable acquisition of the data to be transmitted by the sensor (6) is thereby guaranteed, even when the belt (1) is running at high speed.

The invention relates to a belt having an operative surface and a rear surface, having a data transmission device, wherein the data transmission device has at least one sensor having an energy supply and at least one external reader.

State-dependent maintenance of technical systems is increasingly based on components that are able to acquire their state themselves and communicate it. For this “self-reporting”, the components are fitted with smart electronics that perform measurements (for example of the temperature) and transmit the results to superordinate systems. RFID (radiofrequency identification) transponders having an integrated measurement function and that transmit their data to an external reader via radio in the UHF (ultra-high frequency) frequency band are available on the market, for example.

RFID transponders are suitable for use in belts and conveyor belts only to a limited extent if these revolve at high speeds, because the transponder has to be situated within the range of the external reader or its antenna for the duration of the energy and data transmission. At short range and high revolution speeds, the available time window is not enough to completely transmit the data telegrams.

The electromagnetic properties, such as for example permeability or permittivity of the materials of the belt, detune the RFID transponder to such an extent that its antenna has to be individually matched to the material surroundings.

The invention is based on the object of designing the data transmission device mentioned at the outset such that data from a moving belt are able to be reliably transmitted to a stationary receiver.

This object is achieved in that spaced signal surfaces are arranged on the rear surface of the belt in the running direction of the belt, and each signal surface is able to be switched either into a first active state or into a second inactive state by the sensor, wherein a positive signal is able to be transmitted in the first active state and either a negative signal or no signal is able to be transmitted in the second inactive state, and the respective state of the signal surfaces is able to be acquired by the external reader when the moving belt runs past.

In each case either a “1” state or a “0” state is able to be transmitted by the signal surfaces, in a manner similar to digital switches. The signal sequence of the signal surfaces when the belt is moving is able to be acquired by the external reader when the belt runs past, wherein a binary word known from electronic data processing is able to be generated from the signal sequence. This word is able to be interpreted as the signal acquired and transmitted by the sensor by way of suitable electronics.

In one development of the invention, the belt additionally has a reference surface on the rear surface and an electric voltage is in each case able to be connected between the reference surface and the individual signal surfaces by way of the sensor, wherein each signal surface with an applied voltage is switched into the active state and each signal surface without an applied voltage is switched into the inactive state.

The electrical field that arises when voltage is applied is able to be acquired by corresponding readers. When the moving belt runs past, a signal sequence is thus able to be generated that represents the measured value of the sensor to be transmitted when converted into a binary word.

In one development of the invention, the electric voltage is a DC voltage.

Only very simple drive electronics of the sensor are necessary in order to apply a DC voltage.

In one development of the invention, the electric voltage is an AC voltage having a predetermined alternating frequency.

Electric AC voltages generate alternating fields whose frequency is able to be measured such that, in the time interval during which the signal surfaces overlap with the reader, there are at least ten changes of amplitude. This variant has the advantage that the reader is able to be tuned to the selected frequency in order to suppress interference, for example by filtering, synchronous rectification, etc.

In one development of the invention, the signal surfaces are designed so as to be magnetizable, wherein the polarity of the magnetized signal surfaces is able to be switched by the sensor and a predefined polarity of the individual signal surfaces is associated with the activated state of the signal surface in question.

The magnetic polarity of the individual signal surfaces is also possible with corresponding acquisition appliances, such that a binary word corresponding to the sensor signal is able to be acquired. In this case, it is advantageous for a binary “0” also to be able to be generated by a corresponding active signal of the signal surfaces. The risk of incorrect interpretations, for example due to lack of recognition of an inactive signal surface, is thereby able to be reduced.

In one development of the invention, the signal surfaces are designed so as to be optically reflective and coated with an electrically conductive pigment layer, wherein the alignment of the pigments is able to be changed by applying an electric voltage to the pigments.

This solution makes it possible, in a manner similar to electronic paper, to influence the reflection of the signal surfaces by applying a voltage to the pigments. It is thereby possible to permit or to prevent light reflections from the individual signal surfaces depending on the signal of the sensor. Binary values that correspond to the values to be transmitted by the sensor are thus able to be acquired by way of a suitable reader.

In one development of the invention, the signal surfaces are light-emitting diodes.

Light-emitting diodes have the advantage of ensuring reliable recognition of the signal states of the signal surfaces, even in unfavorable operating conditions. It is down to the respective case of use to decide how the light-emitting diodes should be supplied with the corresponding energy, for example through external electrical induction or energy harvesting using corresponding components in the belt.

In one development of the invention, the belt has an additional trigger surface that is arranged in front of the signal surfaces on the rear surface of the belt in the running direction and by way of which, when the trigger surface runs past the reader, the sensor is able to be driven so as to output control signals to the signal surfaces for a predetermined time.

In this way, the sensor only outputs signals when the signal surfaces run past the reader. Energy is thus able to be saved.

Since only one item of binary information is able to be transmitted per signal surface, the information density, even when the signal surfaces run past the reader at high speed, is low enough that it is possible to reliably acquire the states of the signal surfaces. Reliable acquisition of the data to be transmitted by the sensor is thereby guaranteed, even when the belt is running at high speed.

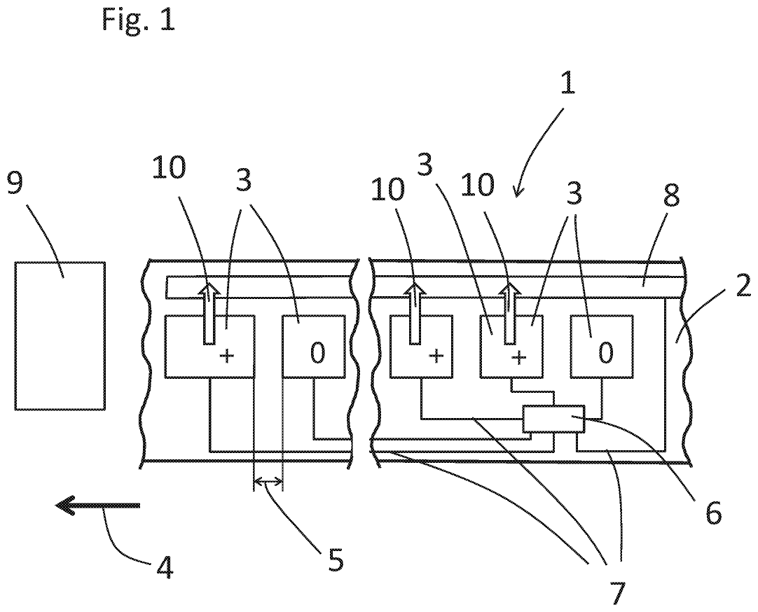

An example of the invention is explained in more detail below on the basis of the drawing. FIG. 1 shows a belt 1 in a basic plan view. The belt 1 has a number of signal surfaces 3 on its rear surface 2. The signal surfaces 3 are all of the same shape and size. A spacing 5 is in each case arranged between the signal surfaces 3 in the running direction 4 of the belt 1. Various measured variables, for example temperature or number of load alternations on the belt 1, are able to be measured by way of a sensor 6. The sensor 6 is connected to each signal surface 3 and also to a reference surface 8 by way of electrical conductors 7. The sensor 6 has an electrical computer unit, not shown, by way of which its measured data are able to be converted into binary data words. The number of bits in the binary data words corresponds to the number of signal surfaces 3. Each bit of the data words is assigned a signal surface 3.

A reader 9 is arranged so as to be spaced from the rear surface 2 of the belt 1 and corresponds, in terms of its position in relation to the signal surfaces 3, to the signal surfaces 3 such that, when the belt 1 moves in the running direction 4, the signal surfaces 3 pass the reader 9 in sequence.

An electric voltage is able to be applied in each case separately between the reference surface 8 and the signal surfaces 3 by the sensor 6 through the electrical conductors 7. For each signal surface 3, an applied voltage in this case represents the binary value “1”. These signal surfaces 3 are selected here by way of example and marked as active by a “+”. If no voltage is applied, this represents the value “0”. The switching surfaces in question are likewise selected here by way of example, but symbolized with a “0”.

An electrical field 10 is able to be generated by an applied voltage on the respective signal surface 3, and the signal surface 3 in question is thus “active”. If no voltage is applied, no electrical field is present, and the signal surface in question is “inactive”.

If the signal surfaces 3 pass the reader 9, an electrical pulse is able to be generated in the reader 9 by the electrical fields of the activated signal surfaces 3. If an inactive switching surface passes, no pulse is generated in the reader 9.

A generated pulse is able to be interpreted as a binary “1” by the reader 9. A binary data word, which matches the data word generated by the sensor 6, is able to be formed in the reader 9 from the individual states of the signal surfaces 3 through the sequence of the signal surfaces 3 passing the reader 9.

Reliable, contactless acquisition of the data acquired by the sensor 6 is thereby easily ensured, even at high running speeds of the belt 1.

The embodiment according to the invention is however not limited to transmission by way of electrical fields. The signal surfaces 3 may thus also be designed as magnetizable elements, wherein the polarity of the magnetization is able to be changed by a voltage applied to the signal surfaces 3 by the sensor 6.

The magnetic field emanating from the signal surfaces 3 is then able to be acquired by the reader 9, wherein a predefined field line formation should be associated with an active signal surface 3, that is to say with a binary “1”. All other field formations correspond to a binary “0”.

In this case, it is advantageous for a binary “0” also to be able to be generated by a corresponding active signal of the signal surfaces 3. The risk of incorrect interpretations during data acquisition is thereby reduced.

The signal surfaces 3 may also be designed as light-reflecting elements to which a pigment layer, not shown here, is applied. The alignment of the pigments, which are not shown here, is able to be changed by an electric voltage that is able to be generated by the sensor 6. The reflectivity of the signal surfaces 3 is thus accordingly able to be influenced, as is already known for electronic paper.

The reader 9 is then accordingly able to acquire reflection values, wherein predetermined reflection values accordingly represent the binary value “1”, for example. The signal surfaces 3 may also be designed as light-emitting diodes, wherein the light-emitting diodes 3 are supplied with energy by an energy source, not shown here. An external energy supply is possible here for example through induction, this however not being shown here.

Light-emitting diodes have the advantage that good data acquisition is possible even in unfavorable operating conditions, since the light-emitting diodes actively illuminate upon a corresponding signal.

### LIST OF REFERENCE SIGNS

### (Part of the Description)

1 Belt
2 Rear surface of the belt 1
3 Signal surfaces
4 Running direction of the belt 1
5 Distance between the signal surfaces 3
6 Sensor
7 Electrical conductor
8 Reference surface
9 Reader
10 Electrical field

1.-8. (canceled)

9. A belt comprising an operative surface and a rear surface, the rear surface comprising a data transmission device, wherein the data transmission device comprises at least one sensor having an energy supply and at least one external reader, wherein spaced signal surfaces are arranged on the rear surface of the belt in a running direction of the belt, and each of the spaced signal surfaces is able to be switched either into a first active state or into a second inactive state by the sensor, wherein a positive signal is able to be transmitted in the first active state and either a negative signal or no signal is able to be transmitted in the second inactive state, and wherein respective states of the spaced signal surfaces are able to be acquired by the at least one external reader when the belt runs past the at least one external reader.

10. The belt as claimed in claim 9, wherein the belt further comprises a reference surface on the rear surface and an electric voltage connected between the reference surface and at least one of the spaced signal surfaces by way of the sensor, wherein each of the spaced signal surfaces with an applied voltage is switched into the first active state, and wherein each signal surface without an applied voltage is switched into the second inactive state.

11. The belt as claimed in claim 10, wherein the electric voltage is a DC voltage.

12. The belt as claimed in claim 10, wherein the electric voltage is an AC voltage having a predetermined alternating frequency.

13. The belt as claimed in claim 9, wherein the spaced signal surfaces are designed so as to be magnetizable, wherein polarity of the spaced signal surfaces when magnetized is able to be switched by the sensor, and wherein a predefined polarity of a spaced signal surface is associated with the activated state of the spaced signal surface in question.

14. The belt as claimed in claim 9, wherein the spaced signal surfaces are designed so as to be optically reflective and coated with an electrically conductive pigment layer, and wherein alignment of pigments comprised in the electrically conductive pigment layer is able to be changed by applying an electric voltage to the electrically conductive pigment layer.

15. The belt as claimed in claim 9, wherein the spaced signal surfaces are light-emitting diodes.

16. The belt as claimed in claim 9, wherein the belt further comprises a trigger surface arranged in front of the spaced signal surfaces on the rear surface of the belt in the running direction and by way of which, when the trigger surface runs past the at least one external reader, the sensor is able to be driven so as to output control signals to the spaced signal surfaces for a predetermined time.
